(19) United States
(12) Patent Application Publication
(10) Pub. No.: US 2006/0131963 A1
(43) Pub. Date: Jun. 22, 2006

(54) Methods and systems for robust switching using multi-state switch contacts

(76) Inventors: Kerfegar K. Katrak, Fenton, MI (US); Paul A. Bauerle, Fenton, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 11/017,386

(22) Filed: Dec. 20, 2004

(51) Int. Cl. G06F 13/40

(52) U.S. Cl. 307/134

(57) ABSTRACT

Systems, methods and devices are described for robustly determining a desired operating state of a controlled device in response to the position of a multi-position actuator. Two or more ternary switch contacts provide input signals representative of the position of the actuator. Control logic then determines the desired state for the controlled device based upon the input signals received. The desired operating state is determined from any number of operating states defined by the input values. Robustness is provided by selecting each of the operating states such that transitions between any operating states to another result from changes in each of the first and second ternary input values.

### TECHNICAL FIELD

The present invention generally relates to multi-state switching logic, and more particularly relates to robust methods, systems and devices for processing multi-state data.

### BACKGROUND

Modern vehicles contain numerous electronic and electrical switches. Vehicle features such as climate controls, audio system controls other electrical systems and the like are now activated, deactivated and adjusted in response to electrical signals generated by various switches in response to driver/passenger inputs, sensor readings and the like. These electrical control signals are typically relayed from the switch to the controlled devices via copper wires or other electrical conductors. Presently, many control applications use a single wire to indicate two discrete states (e.g. ON/OFF, TRUE/FALSE, HIGH/LOW, etc.) using a high or low voltage transmitted on the wire.

To implement more than two states, additional control signals are typically used. In a conventional two/four wheel drive transfer control, for example, four active states of the control (e.g. 2WD mode, auto 4WD mode, 4WD LO mode and 4WD HI mode) as well as a default mode are represented using three to five discrete two-state switches coupled to a single or dual-axis control lever. As the lever is actuated, the various switches identify the position of the lever to place the vehicle in the desired mode. Power take-off (PTO) controls also typically contain three or more discrete switches to represent the various states of the PTO device, which is commonly used to power upfitter-installed accessories such as bucket lifts, snow plows, lift dump bodies and the like. Numerous other multi-state switches use multiple discrete switches to represent the various positions of a single or dual-axis control mechanism, which in turn represent the various states of a controlled device.

As consumers demand additional electronic features in newer vehicles, the amount of wiring present in the vehicle continues to increase. This additional wiring occupies valuable vehicle space, adds undesirable weight to the vehicle and increases the manufacturing complexity of the vehicle. There is therefore an ongoing need in vehicle applications to reduce the amount of wiring in the vehicle without sacrificing features. Further, there is a need to increase the number of features in the vehicle without adding weight, volume or complexity commonly associated with additional wiring, and without sacrificing safety. Still further, there is a demand for robust switches and switching systems that are reliable and dependable, particularly in the automotive setting.

In particular, it is desirable to formulate multi-state switching devices that reduce the cost, complexity and weight associated with multiple input switches, wires and other components without sacrificing safety or robustness. Furthermore, other desirable features and characteristics will become apparent from the subsequent detailed description and the appended claims, taken in conjunction with the accompanying drawings and the foregoing technical field and background.

### BRIEF SUMMARY

Systems, methods and devices are described for robustly determining a desired operating state of a controlled device in response to the position of a multi-position actuator. Two or more ternary switch contacts provide input signals representative of the position of the actuator. Control logic then determines the desired state for the controlled device based upon the input signals received. The desired operating state is determined from any number of operating states defined by the ternary input values. Robustness is provided through proper selection of signal settings used to represent various operating states, as well as through mechanical interlocking and/or other techniques.

### BRIEF DESCRIPTION OF THE DRAWINGS

The present invention will hereinafter be described in conjunction with the following drawing figures, wherein like numerals denote like elements, and:

FIG. 1 is a block diagram of an exemplary vehicle;

FIG. 2 is a circuit diagram of an exemplary embodiment of a switching circuit;

FIG. 3 is a circuit diagram of an alternate exemplary embodiment of a switching circuit;

FIG. 4A is a diagram of an exemplary switching system for processing input signals from multiple switches;

FIG. 4B is a diagram of an exemplary switching system for processing input signals from multiple interlocked switches; and

FIG. 5 is a logic diagram for an exemplary decoder module.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

According to various exemplary embodiments, single and/or multi-axis controls for use in vehicles and elsewhere may be formulated with ternary switches to reduce the complexity of the control. Such switches may be used to implement robust selection schemes for various types of control mechanisms, including those used for Normal/Performance/Economy mode switching, cruise control switching, power take off (PTO) controls, “tap up/tap down” switching and/or the like. Further, by selecting certain signal input combinations to represent the operating states of the controlled device and/or through mechanical interlocking of multiple switch contacts, the robustness of the system can be preserved, or even improved.

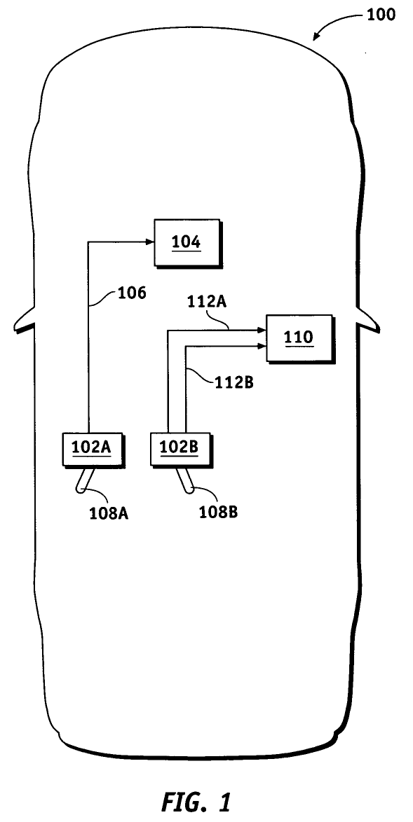

Turning now to the drawing figures and with initial reference to FIG. 1, an exemplary vehicle 100 suitably includes any number of components 104, 110 communicating with various switches 102A, 102B to receive control signals 106, 112A-B, respectively. The various components 104, 110 may represent any electric or electronic devices present within vehicle 100, including, without limitation, 2WD/4WD transfer case controls, cruise controls, power take off selection/actuation devices, multi-position selectors, digital controllers coupled to such devices and/or any other electrical systems, components or devices within vehicle 100.

Switches 102A-B are any devices capable of providing various logic signals 106, 112A-B to components 104, 110 in response to user commands, sensor readings or other input stimuli. In an exemplary embodiment, switches 102A-B respond to displacement or activation of a lever 108A-B or other actuator as appropriate. Various switches 102A-B may be formulated with electrical, electronic and/or mechanical actuators to produce appropriate ternary output signals onto one or more wires or other electrical conductors joining switches 102 and components 104, 110, as described more fully below. These ternary signals may be processed by components 104, 110 to place the components into desired states as appropriate. In various embodiments, a single ternary signal 106 may be provided (e.g. between switch 102A and component 104 in FIG. 1), and/or multiple signals 112A-B may be provided (e.g. between switch 102B and component 110 in FIG. 1), with logic in component 104 (or an associated controller) combining or otherwise processing the various signals 112A-B to extract meaningful instructions. In still further embodiments, binary, ternary and/or other signals may be combined in any suitable manner to create any number of switchable states.

Many types of actuator or stick-based control devices provide several output signals 112A-B that can be processed to determine the state of a single actuator 108B. Lever 108B may correspond to the actuator in a 2WD/4WD selector, electronic mirror control, power take off selector or any other device operating within one or more degrees of freedom. In alternate embodiments, lever 108A-B moves in a ball-and-socket or other arrangement that allows multiple directions of movement. The concepts described herein may be readily adapted to operate with any type of mechanical selector, including any type of lever, stick, or other actuator that moves with respect to the vehicle via any slidable, rotatable or other coupling (e.g. hinge, slider, ball-and-socket, universal joint, etc.).

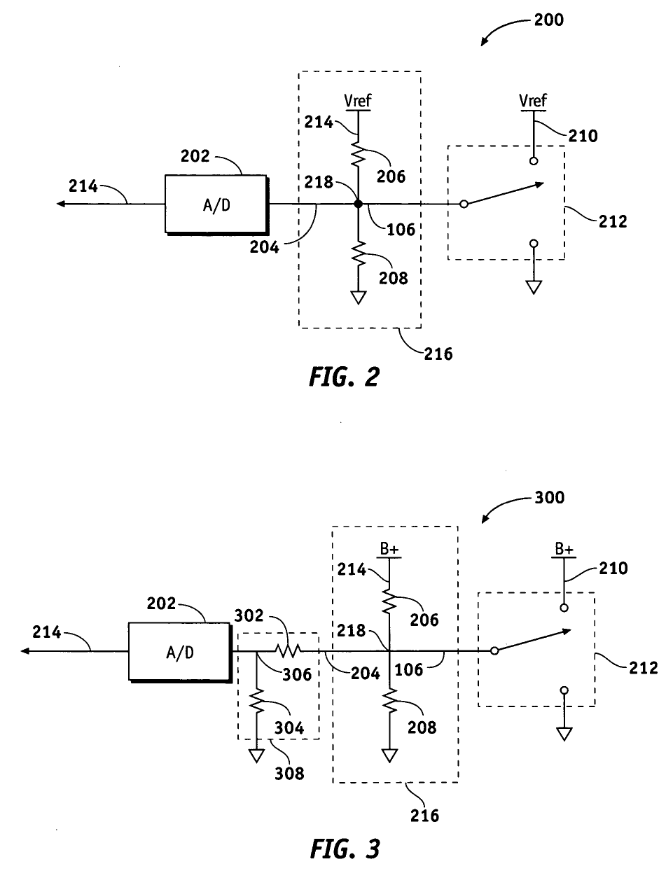

Referring now to FIG. 2, an exemplary switching circuit 200 suitably includes switch contacts 212, a voltage divider circuit 216 and an analog-to-digital (A/D) converter 202. Switch contacts 212 suitably produce a three-state output signal that is appropriately transmitted across conductor 106 and decoded at voltage divider circuit 216 and/or A/D converter 202. The circuit 200 shown in FIG. 2 may be particularly useful for embodiments wherein a common reference voltage (V_{ref}) for A/D converter 202 is available to switch contacts 212 and voltage divider circuit 216, although circuit 200 may be suited to array of alternate environments as well.

Switch contacts 212 are any devices, circuits or components capable of producing a binary, ternary or other appropriate output on conductor 106. In various embodiments, switch contacts 212 are implemented with a conventional double-throw switch as may be commonly found in many vehicles. Alternatively, contacts 212 are implemented with a multi-position operator or other voltage selector as appropriate. Contacts 212 may be implemented with a conventional three-position low-current switch, for example, as are commonly found on many vehicles. Various of these switches optionally include a spring member (not shown) or other mechanism to bias an actuator 106 (FIG. 1) into a default position, although bias mechanisms are not found in all embodiments. Switch contacts 212 conceptually correspond to the various switches 102A-B shown in FIG. 1.

Switch contacts 212 generally provide an output signal selected from two reference voltages (such as a high reference voltage (e.g. V_{ref}) and a low reference voltage (e.g. ground)), as well as an intermediate value. In an exemplary embodiment, V_{ref} is the same reference voltage provided to digital circuitry in vehicle 100 (FIG. 1), and may be the same reference voltage provided to A/D converter 202. In various embodiments, V_{ref} is on the order of five volts or so, although other embodiments may use widely varying reference voltages. The intermediate value provided by contacts 212 may correspond to an open circuit (e.g. connected to neither reference voltage), or may reflect any intermediate value between the upper and lower reference voltages. An intermediate open circuit may be desirable for many applications, since an open circuit will not typically draw a parasitic current on signal line 106 when the switch is in the intermediate state, as described more fully below. Additionally, the open circuit state is relatively easily implemented using conventional low-current three-position switch contacts 212.

Contacts 212 are therefore operable to provide a ternary signal 106 selected from the two reference signals (e.g. V_{ref} and ground in the example of FIG. 2) and an intermediate state. This signal 106 is provided to decoder circuitry in one or more vehicle components (e.g. components 104, 110 in FIG. 1) as appropriate. In various embodiments, the three-state switch contact 212 is simply a multi-position device that merely selects between the two reference voltages (e.g. power and ground) and an open circuit position or other intermediate condition. The contact is not required to provide any voltage division, and consequently does not require electrical resistors, capacitors or other signal processing components other than simple selection apparatus. In various embodiments, switch 212 optionally includes a mechanical interlocking capability such that only one state (e.g. power, ground, intermediate) can be selected at any given time.

The signals 106 produced by contacts 212 are received at a voltage divider circuit 216 or the like at component 104, 110 (FIG. 1). As shown in FIG. 2, an exemplary voltage divider circuit 216 suitably includes a first resistor 206 and a second resistor 208 coupled to the same high and low reference signals provided to contacts 212, respectively. These resistors 206, 208 are joined at a common node 218, which also receives the ternary signal 106 from switch 212 as appropriate. In the exemplary embodiment shown in FIG. 2, resistor 206 is shown connected to the upper reference voltage V_{ref} 214 while resistor 208 is connected to ground. Resistors 206 and 208 therefore function as pull-down and pull-up resistors, respectively, when signals 106 correspond to ground and V_{ref}. While the values of resistors 206, 208 vary from embodiment to embodiment, the values may be selected to be approximately equal to each other such that the common node is pulled to a voltage of approximately half the V_{ref} voltage when an open circuit is created by contact 212. Hence, three distinct voltage signals (i.e. ground, V_{ref}/2, V_{ref}) may be provided at common node 218, as appropriate. Alternatively, the magnitude of the intermediate voltage may be adjusted by selecting the respective values of resistors 206, 208 accordingly. In various embodiments, resistors 206, 208 are both selected as having a resistance on the order of about 1-50 kOhms, for example about 10 kOhms, although any other values could be used in a wide array of alternate embodiments. Relatively high resistance values may assist in conserving power and heat by reducing the amount of current flowing from V_{ref} to ground, although alternate embodiments may use different values for resistors 206, 208.

The ternary voltages present at common node 208 are then provided to an analog-to-digital converter 202 to decode and process the signals 204 as appropriate. In various embodiments, A/D converter 202 is associated with a processor, controller, decoder, remote input/output box or the like. Alternatively, A/D converter 202 may be a comparator circuit, pipelined A/D circuit or other conversion circuit capable of providing digital representations 214 of the analog signals 204 received. In an exemplary embodiment, A/D converter 202 recognizes the high and low reference voltages, and assumes intermediate values relate to the intermediate state. In embodiments wherein V_{ref} is equal to about five volts, for example, A/D converter may recognize voltages below about one volt as a “low” voltage, voltages above about four volts as a “high” voltage, and voltages between one and four volts as intermediate voltages. The particular tolerances and values processed by A/D converter 202 may vary in other embodiments.

As described above, then, ternary signals 106 may be produced by contacts 212, transmitted across a single carrier, and decoded by A/D converter 202 in conjunction with voltage divider circuit 216. Intermediate signals that do not correspond to the traditional “high” or “low” outputs of contact 212 are scaled by voltage divider circuit 216 to produce a known intermediate voltage that can be sensed and processed by A/D converter 202 as appropriate. In this manner, conventional switch contacts 212 and electrical conduits may be used to transmit ternary signals in place of (or in addition to) binary signals, thereby increasing the amount of information that can be transported over a single conductor. This concept may be exploited across a wide range of automotive and other applications.

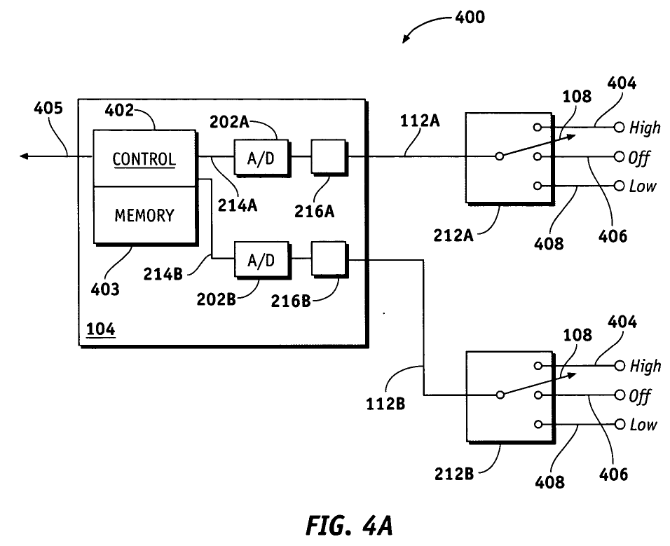

Referring now to. FIG. 3, an alternate embodiment of a switching circuit 300 suitably includes an additional voltage divider 308 in addition to contact 212, divider circuit 216 and A/D converter 202 described above in conjunction with FIG. 2. The circuit shown in FIG. 3 may provide additional benefit when one or more reference voltages (e.g. V_{ref}) provided to A/D converter 202 are unavailable or inconvenient to provide to contact 212. In this case, another convenient reference voltage (e.g. a vehicle battery voltage B⁺, a run/crank signal, or the like) may be provided to contact 212 and/or voltage divider circuit 216 as shown. Using the concepts described above, this arrangement provides three distinct voltages (e.g. ground, B⁺/2 and B⁺) at common node 204. These voltages may be out-of-scale with those expected by conventional A/D circuitry 202, however, as exemplary vehicle battery voltages may be on the order of twelve volts or so. Accordingly, the voltages present at common node 204 are scaled with a second voltage divider 308 to provide input signals 306 that are within the range of sensitivity for A/D converter 202.

In an exemplary embodiment, voltage divider 308 includes two or more resistors 302 and 304 electrically arranged between common node 208 and the input 306 to A/D converter 202. In FIG. 3, resistor 302 is shown between nodes 208 and 306, with resistor 304 shown between node 306 and ground. Various alternate divider circuits 308 could be formulated, however, using simple application of Ohm's law. Similarly, the values of resistors 302 and 304 may be designed to any value based upon the desired scaling of voltages between nodes 218 and 306, although designing the two resistors to be approximately equal in value may provide improved signal-to-noise ratio for circuit 300.

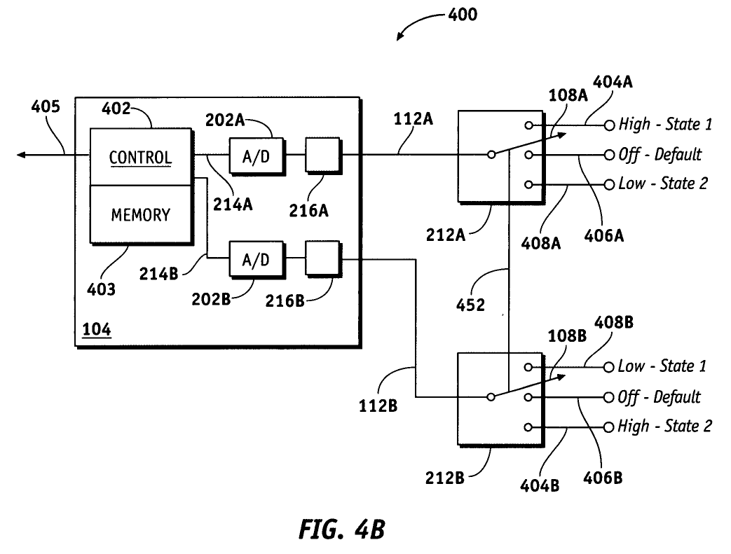

Using the concepts set forth above, a wide range of control circuits and control applications may be formulated, particularly within automotive and other vehicular settings. As mentioned above, the binary and/or ternary signals 106 produced by contacts 212 may be used to provide control data to any number of vehicle components 104, 110 (FIG. 1). With reference now to FIGS. 4A-B, the various positions 404, 406, 408 of contacts 212A-B may be appropriately mapped to various states, conditions or inputs 405 provided to component 104. As described above, component 104 suitably includes (or at least communicates with) a processor or other controller 402 that includes or communicates with A/D converter 202 and voltage divider circuit 210 to receive ternary signals 112A-B from contacts 212. The digital signals 214 produced by A/D converter 202 are processed by controller 402 as appropriate to respond to the three-state input received at contacts 212. Accordingly, mapping between states 404, 406 and 408 is typically processed by controller 402, although alternate embodiments may include signal processing in additional or alternate portions of system 400. Signals 214 received from contacts 212 may be processed in any appropriate manner, and in a further embodiment may be stored in a digital memory 403 as appropriate. Although shown as separate components in FIGS. 4A-B, memory 403 and processor 402 may be logically and/or physically integrated in any manner. Alternatively, memory 403 and processor 402 may simply communicate via a bus or other communications link as appropriate.

Although FIGS. 4A-B show exemplary embodiments wherein controller 402 communicates with two switches 212A-B, alternate embodiments may use any number of switches 212, as described more fully below. The various outputs 214A-B of the switching circuits may be combined or otherwise processed by controller 402, by separate processing logic, or in any other manner, to arrive at suitable commands provided to device 104. The commands resulting from this processing may be used to place device 104 into a desired state, for example, or to otherwise adjust the performance or status of the device. In various embodiments, a desired state of device 104 is determined by comparing the various input signals 214A-B received from contacts 212A-B (respectively). The state of device 104, then, can be determined by the collective states of the various input signals 214A-B.

As used herein, input state 404 is arbitrarily referred to as ‘1’ or ‘high’ and corresponds to a short circuit to V_{ref}, B⁺ or another high reference voltage. Similarly, input state 408 is arbitrarily referred to as ‘0’ or ‘low’, and corresponds to a short circuit to ground or another appropriate low reference voltage. Intermediate input state 406 is arbitrarily described as ‘value’ or ‘v’, and may correspond to an open circuit or other intermediate condition of switch 212. Although these designations are applied herein for consistency and ease of understanding, the ternary states may be equivalently described using other identifiers such as “0”, “1” and “2”, “A”, “B” and “C”, or in any other convenient manner. The naming and signal conventions used herein may therefore be modified in any manner across a wide array of equivalent embodiments.

In many embodiments, intermediate state 406 of contacts 212 is most desirable for use as a “power off”, “default” or “no change” state of device 104, since the open circuit causes little or no current to flow from contacts 212, thereby conserving electrical power. Moreover, an ‘open circuit’ fault is typically more likely to occur than a faulty short to either reference voltage; the most likely fault (e.g. open circuit) conditions may therefore be used to represent the least disruptive states of device 104 to preserve robustness. Short circuit conditions, for example, may be used to represent an “OFF” state of device 104. In such systems, false shorts would result in turning device 104 off rather than improperly leaving device 104 in an “ON” state. On the other hand, some safety-related features (e.g. headlights) may be configured to remain active in the event of a fault, if appropriate. Accordingly, the various states of contacts 212 described herein may be re-assigned in any manner to represent the various inputs and/or operating states of component 104 as appropriate.

Using the concepts of ternary switching, various exemplary mappings of contacts 212 for certain automotive and other applications may be defined as set forth below. The concepts described above may be readily implemented to create a multi-state control that could be used, for example, to control a power takeoff, powertrain component, climate or audio component, cruise control, other mechanical and/or electrical component, and/or any other automotive or other device. In such embodiments, two or more switches are generally arranged proximate to an actuator 108, with the outputs of the switches corresponding to the various states/positions of actuator 108. Alternatively, however, the two switches could interact with separate actuators 108, with the various input states representing the various positions of the distinct actuators. Stated another way, a common controller 402 may be used to decode the various states of multiple switch contacts 212A-B. Further, any number of binary, ternary and/or other types of switch contacts 212 may be interconnected or otherwise inter-mixed to create switching arrangements of any type.

The various mappings and arrangements of input signals used to represent the states of device 104 may be assigned in any manner. In various embodiments, however, certain combinations of input signals may provide various benefits such as reduced electrical current consumption, improved safety, or the like. Accordingly, by choosing the particular combinations of input signals used to represent the various operating states of device 104, control system 400 can be designed for improved performance.

By associating the “default” state for device 104 with one or more “open circuit” positions of contacts 212, for example, the amount of current consumed when the device is in the default position may be suitably reduced, since little or no current flows through the contact 212 when the contact is in the intermediate “open circuit” state. Because very little current flows while the switch is in this state, current consumption is minimized in the default state of device 104.

Further, using the assumption that open circuits are more likely to be encountered than shorts to ground, which in turn are more likely than shorts to the battery voltage (B⁺), the various device states can be mapped to the inputs such that least-desired state is associated with the input conditions that are least likely to occur accidentally. Using the previous assumptions in the embodiment shown in FIG. 4A, for example, a first operating state for a device 104 may correspond to both input contacts 212A-B being coupled to the “high” reference voltage 404, a second operating state could correspond to both contacts being coupled to the “low” reference voltage 408, and the default/operating/“no change” state may correspond to both contacts 212 being in the intermediate state 406. This arrangement reduces current consumption during the default state and makes accidental engagement of the controlled device 104 less likely than accidental disengagement. Although the three operating states of device 104 could theoretically be represented by a single set of three-state switch contacts 212, the additional input provides redundancy that improves the safety or “robustness” of the system.

The control system 400 may be made even more robust by selecting the operating state conditions to increase the number of signal transitions used to alter the operating state of device 104, as discussed more fully above. By increasing the number of signal transitions required to switch device 104 between two different states, the likelihood of an accidental state transition caused by a faulty switch or other factors is significantly reduced, thereby making the system more robust. If each state change requires at least two signal transitions, for example, the system is insulated against accidental state changes caused by a single broken wire, faulty contact 212 or the like. This concept can be exploited to improve the robustness of the control system 400.

Generally speaking, two ternary switches are capable of representing nine distinct states, as shown in TABLE 1 below:

TABLE 1

| State | Input1 | Input2 |
|---|---|---|
| 1 | 0 | 0 |
| 2 | 0 | v |
| 3 | 0 | 1 |
| 4 | v | 0 |
| 5 | v | v |
| 6 | v | 1 |
| 7 | 1 | 0 |
| 8 | 1 | v |
| 9 | 1 | 1 |

In embodiments wherein only three operating states of device 104 need to be represented, however, the three sets of inputs used to represent the three operating states may be chosen to improve the robustness of system 400. That is, the sets may be chosen such that any change from one state to another involves at least two signal transitions. By choosing, for example, sets three, five and seven in Table 1 to represent the three operating states of the controlled device, each state change would require transitions in the values of both input1 and input 2.

With particular reference now to FIG. 4B, an exemplary control system 400 with enhanced robustness suitably includes two or more switch contacts 212A-B with actuators 108A-B that are mechanically interlocked such that movement of one actuator 108 results in movement of the other. Stated another way, movement of actuator 108 simultaneously produces electrical activity at both contacts 212A and 212B. FIG. 4B shows mechanical interlocking of two distinct actuators 108A-B though an interconnecting member 452. Alternatively, contacts 212A and 212B may be arranged proximate to a single actuator 108 to provide interlocking, or other physical arrangements could be formulated. FIG. 4B also shows contacts 212A-B configured such that contacts 212B produce a “low” signal 112B when contacts 212A produce a high signal 112A, and vice versa. This phenomenon may be produced through any mechanical, electrical or other physical configuration of contacts 212A-B, and may vary widely from embodiment to embodiment.

The various positions of actuator 108 may therefore be indicated by the values of signals 112A and 112B. In the example shown in FIG. 4B, for example, the three positions of actuator 108 (corresponding to three operating modes/states of controlled device 104/110) are shown as “State1”, “State2” and “Default”. State1 is represented by actuator 108 being in contact with the high reference 404A of contact 212A and the low reference 408B of contact 212B. State 2 is represented by actuator 108 being in contact with the low reference 408A of contact 212A and the high reference 404B of contact 212B. The third “Default” state is represented by the actuator 108 being in the intermediate/off/open circuit position 406A-B of each contact 212A-B. Other signal configurations could be used in a wide array of alternate embodiments.

In the embodiment of FIG. 4B, the opposing signals 112A and 112B provide enhanced robustness of system 400 by indicating movement of actuator 108 with multiple signal transitions. That is, as actuator 108 moves between State1, Default and State2, both signals 112A and 112B will transition between the “high”, “low” and/or “off” state with each change in actuator position. Because each state change of actuator 108 results in a value transition for each signal 112A and 112B, redundancy is provided that reduces the likelihood of a fault. Moreover, because each state transition involves both the “low” and “high” reference signals, undesired state transitions will not typically occur even if one of the references sources should become unavailable, further enhancing the robustness of system 400.

Any state in TABLE 1 may be associated with any position of the actuator 108 by simply changing the reference voltages (e.g. ground, battery, open circuit) coupled to the switch contacts for the various positions of actuator 108. Various robust state combinations could therefore be used in a wide array of equivalent embodiments. Examples of other combinations of signal inputs suitable for use in robust three-state switches include states 1, 5 and 9; states 2, 4 and 9; states 3, 4 and 8; states 3, 5 and 7; states 1, 6 and 8; and states 2, 6 and 7 (as described in TABLE 1). Each of these state combinations could be used to create robust switching arrangements wherein state changes result only from multiple signal transitions. State 1 could be used as a default state in alternate embodiments, for example, with any other two states (e.g. states 6 and 8) representing the other two active states. In various further optional embodiments, any unused states could be used as “diagnostic states”, with occurrences of the non-assigned states indicating the occurrence of one or more faults or other undesirable conditions.

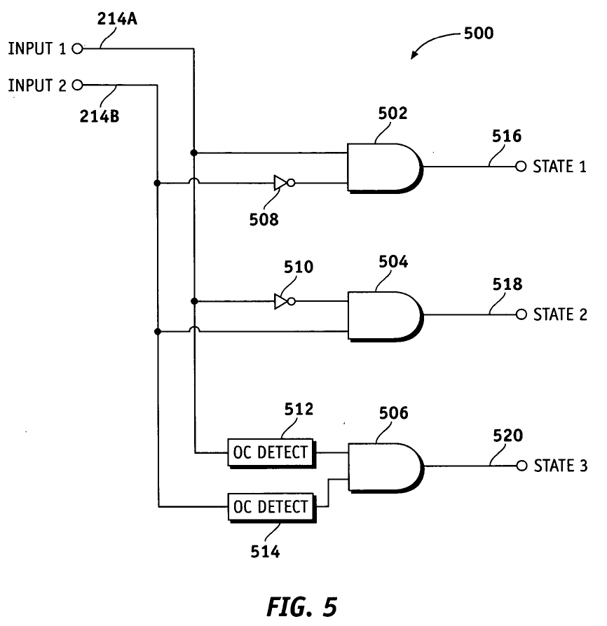

In various embodiments, the outputs of the switches may be processed using conventional software logic, logic gates (e.g. AND/NAND, OR/NOR or the like) and/or processing circuitry to determine the state of the actuator. Turning to FIG. 5, for example, a conceptual logic diagram 500 for decoding the desired state of device 104 suitably includes any number of processing gates 502, 504, 506, 508, 510, 512, 514 as appropriate. Each of these gates may be implemented in any manner. In various embodiments, each of the gates are implemented with software instructions residing within memory 403 (FIG. 4) and executed by controller 402. Alternatively, decoding logic 500 may be implemented using discrete, integrated or other components, or with any other combination of hardware and/or software.

In the exemplary embodiment shown in FIG. 5, a first detected state 516 represents input signal 214A being logically “high” and input signal 214B being logically “low”, corresponding to contacts 212A and 212B being coupled to the “high” and “low” reference voltages, respectively, corresponding to the “State1”. This state, which corresponds to the “State1” state shown in FIG. 4B, is shown detected with a conventional digital logic inverter 508 and with a conventional digital AND gate 502. Similarly, the second detected state 518 represent input signal 214A being logically “low” and input signal 214B being logically “high”, corresponding to contacts 212A and 212B being coupled to the “low” and “high” reference voltages, respectively. This state corresponds to the “State2” state shown in FIG. 4B, and may be suitably detected with a conventional digital logic inverter 510 and a conventional digital AND gate 502. The third detected state 520 represents both input signals 214A and 214B being in the intermediate state (e.g. “value” or “v”), corresponding to both contacts 212A-B being in the open circuit or other intermediate position. This intermediate/Default/State3 state can be detected with conventional circuitry 512, 514 as appropriate. By varying the arrangement of logical operators within decoder 500, any combination of input signals 214A-B can be mapped to any number of output states 516, 518, 520, etc.

These concepts may be applied in any number of practical settings, including various settings in automotive and other environments. By mapping State1, State2 and State3/Default to various operating modes of a controlled device, numerous embodiments could be formulated across a wide array of commercial and other settings.

The various states of switching system 400 could be mapped to “economy”, “performance” and “normal” operating modes of an engine or other vehicle component, for example. In such embodiments, the normal operating mode could correspond to the “Default”/State3 mode shown in FIGS. 4B and 5 to reduce the amount of current flow during normal operation. Similarly, the two non-default states (e.g. “State1” and “State2”) could be readily associated with transitional states such that even a momentary or other temporary movement of actuator 108 to the corresponding location would result in a state change of the controlled device. Such a system could be used to implement a “tap up”/“tap down” type of switch, for example, wherein momentary placement of actuator 108 into State 1 or State 2 results in a change of state in the controlled device. When actuator 108 is not in the State1 or State2 position, a default action or no action may be assigned to State3. Such functionality may be useful in audio or climate controls, for example, as well as in engine controls or other adjustable controls. Similar concepts could be applied in cruise control systems, for example, with State1 and State2 suitably corresponding to application of “Set/Coast”, “Resume/Accelerate” or other commands to a cruise control. In still other embodiments, control signals could be provided to a power takeoff, with State1 and State2 representing so-called “set1” and “set2” operating modes. Such operating modes could correspond to engine speed settings, for example, which could be used for increasing or decreasing the engine speed during PTO operation as appropriate. Again, the concepts described herein could be applied across a wide array of equivalent automotive and other applications.

The general concepts described herein could be modified in many different ways to implement a diverse array of equivalent multi-state switches, actuators and other controls. The various positions of actuator 108 may be extracted and decoded through any type of processing logic, including any combination of discrete components, integrated circuitry and/or software, for example. Moreover, the various positional and switching structures shown in the figures and tables contained herein may be modified and/or supplemented in any manner. Still further, the concepts presented herein may be applied to any number of ternary and/or discrete switches, or any combination of ternary and discrete switches to create any number of potential or actual robust and non-robust state representations. Similar concepts to those described above could be applied to three or more input signals, for example, allowing for control systems capable of processing any number of robust states in a wide array of equivalent embodiments.

Although the various embodiments are most frequently described with respect to automotive applications, the invention is not so limited. Indeed, the concepts, circuits and structures described herein could be readily applied in any commercial, home, industrial, consumer electronics or other setting. Ternary switches and concepts could be used to implement a conventional joystick, for example, or any other pointing/directing device based upon four or more directions. The concepts described herein could similarly be readily applied in aeronautical, aerospace, marine or other vehicular settings as well as in the automotive context.

While at least one exemplary embodiment has been presented in the foregoing detailed description, a vast number of variations exist. The various circuits described herein may be modified through conventional electrical and electronic principles, for example, or may be logically altered in any number of equivalent embodiments without departing from the concepts described herein. The exemplary embodiments described herein are intended only as examples, and are not intended to limit the scope, applicability, or configuration of the invention in any way. Rather, the foregoing detailed description will provide those skilled in the art with a convenient road map for implementing one or more exemplary embodiments. Various changes can therefore be made in the functions and arrangements of elements set forth herein without departing from the scope of the invention as set forth in the appended claims and the legal equivalents thereof.

What is claimed is:

1. A robust control system for placing a controlled device into a desired operating state in response to a position of a multi-position actuator, the system comprising:
a first switch contact coupled to the multi-position actuator and configured to provide a first ternary input value as a function of the state of the multi-position actuator;
a second switch contact coupled to the multi-position actuator and configured to provide a second ternary input value as a function of the position of the multi-position actuator; and
control logic configured to receive the first and second ternary input values and to determine the desired operating state from a plurality of operating states for the controlled device based upon the first and second ternary input values received, wherein each of the plurality of operating states are represented by a unique combination of the first and second ternary input values selected such that any transition from one of the plurality of operating states to another of the plurality of operating states results from a transition in both the first and second ternary input values.

2. The control system of claim 1 wherein the first and second ternary input values are each selected from a high value, a low value and an intermediate value.

3. The control system of claim 2 wherein one of the plurality of operating states is represented by the first ternary input value having the high value and the second ternary input signal having the low value.

4. The control system of claim 3 wherein a second one of the plurality of operating states is represented by the first ternary input value having the low value and the second ternary input signal having the high value.

5. The control system of claim 4 wherein a third one of the plurality of operating states is represented by the first and second ternary input values each having the intermediate value.

6. The control system of claim 5 wherein the third one of the plurality of operating states corresponds to a default operating state.

7. The control system of claim 2 wherein the intermediate value corresponds to an open circuit condition at the first or second switch contact.

8. The control system of claim 1 wherein the plurality of operating states comprises first and second operating states each determined by the first and second ternary input values having opposite values.

9. The control system of claim 8 wherein the plurality of operating states comprises a third operating state determined by the first and second ternary input values each having an intermediate value.

10. The control system of claim 2 wherein the first ternary input value exhibits the intermediate value in the first operating state, the high value in the second operating state, and the low value in the third operating state, and wherein the second ternary input value exhibits the high value in the first operating state, the intermediate value in the second operating state, and the low value in the third operating state.

11. The control system of claim 10 wherein the third operating state is a default state.

12. The control system of claim 1 wherein the controlled device is a cruise control.

13. The control system of claim 9 wherein the controlled device is a cruise control and the first and second operating states correspond to Set/Coast and Resume/Accelerate states of the automotive cruise control, respectively.

14. The control system of claim 11 wherein the third operating state corresponds to a default state of the cruise control.

15. The control system of claim 1 wherein the controlled device is a power takeoff.

16. The control system of claim 9 wherein the controlled device is a power takeoff and the first and second operating states correspond to Set1 and Set2 states of the power takeoff, respectively.

17. The control system of claim 16 wherein the Set1 and Set2 states correspond to pre-set engine speeds.

18. The control system of claim 16 wherein the third operating state corresponds to a default state of the power takeoff.

19. The control system of claim 1 wherein the plurality of operating modes comprise Normal, Performance and Economy modes.

20. The control system of claim 9 wherein the first and second operating states correspond to Performance and Economy states of the controlled device.

21. The control system of claim 20 wherein the third operating state corresponds to a Normal state of the controlled device.

22. The control system of claim 9 wherein first and second operating states correspond to Tap Up and Tap Down operating states, respectively.

23. A robust control system for placing a power takeoff into a desired mode in response to a position of a multi-position actuator, wherein the desired mode is selected from a plurality of modes comprising at least a Set1 mode, a Set2 mode and a default mode, the system comprising:
a first switch contact coupled to the multi-position actuator and configured to provide a first ternary input value as a function of the state of the multi-position actuator;
a second switch contact coupled to the multi-position actuator and configured to provide a second ternary input value as a function of the position of the multi-position actuator; and
control logic configured to receive the first and second ternary input values and to determine the desired operating state of the power takeoff based at least in part upon the first and second ternary input values received, wherein the Set1 and Set2 modes are selected when the first and second ternary input values having opposite values, and wherein the default mode is selected when both the first and second ternary input values having an intermediate value.

24. A robust control system for placing a controlled device into a desired mode in response to a position of a multi-position actuator, wherein the desired mode is selected from a plurality of modes comprising at least a normal mode, an economy mode and a performance mode, the system comprising:
a first switch contact coupled to the multi-position actuator and configured to provide a first ternary input value as a function of the state of the multi-position actuator;
a second switch contact coupled to the multi-position actuator and configured to provide a second ternary input value as a function of the position of the multi-position actuator; and
control logic configured to receive the first and second ternary input values and to determine the desired operating state of the controlled device based at least in part upon the first and second ternary input values received, wherein the economy and performance modes are selected when the first and second ternary input values exhibit opposite values, and wherein the normal mode is selected when both the first and second ternary input values exhibit an intermediate value.

25. A robust control system for placing a power takeoff into a desired mode in response to a position of a multi-position actuator, wherein the desired mode is selected from a plurality of modes comprising two selectable operating modes and a default mode, the system comprising:
a first switch contact coupled to the multi-position actuator and configured to provide a first ternary input value as a function of the state of the multi-position actuator;
a second switch contact coupled to the multi-position actuator and configured to provide a second ternary input value as a function of the position of the multi-position actuator; and
control logic configured to receive the first and second ternary input values and to determine the desired operating state of the power takeoff based at least in part upon the first and second ternary input values received, wherein the one of the two selectable operating modes is selected when the first and second ternary input values exhibit opposite values, and wherein the default mode is selected when both the first and second ternary input values exhibit an intermediate value.

26. A robust control system for placing a vehicle cruise control into a desired mode in response to a position of a multi-position actuator, wherein the desired mode is selected from a plurality of modes comprising at least a normal mode, a Set/Coast mode and a Resume/Accelerate mode, the system comprising:
a first switch contact coupled to the multi-position actuator and configured to provide a first ternary input value as a function of the state of the multi-position actuator;
a second switch contact coupled to the multi-position actuator and configured to provide a second ternary input value as a function of the position of the multi-position actuator; and
control logic configured to receive the first and second ternary input values and to determine the desired operating state of the controlled device based at least in part upon the first and second ternary input values received, wherein the Set/Coast and Resume/Accelerate modes are selected when the first and second ternary input values exhibit opposite values, and wherein the normal mode is selected when both the first and second ternary input values exhibit an intermediate value.

27. A robust control system for providing a tap up or tap down signal to a controlled device in response to a position of a multi-position actuator, the system comprising:
a first switch contact coupled to the multi-position actuator and configured to provide a first ternary input value as a function of the state of the multi-position actuator;
a second switch contact coupled to the multi-position actuator and configured to provide a second ternary input value as a function of the position of the multi-position actuator; and
control logic configured to receive the first and second ternary input values and to determine a desired signal provided to the controlled device based at least in part upon the first and second ternary input values received, wherein the tap up signal is provided when the first and second ternary input values exhibit a first opposite pair of values, wherein the tap down signal is provided when the first and second ternary input values exhibit a second opposite pair of values, and wherein no change is indicated when both the first and second ternary input values exhibit an intermediate value.

28. A method of determining a desired operating state of a controlled device from a position of a multi-position actuator, the method comprising the steps of:
receiving a first ternary signal having a low value, an intermediate value or a high value indicative of the position of the multi-position actuator with respect to a first switch contact;
receiving a second ternary signal having the low value, the intermediate value or the high value indicative of the position of the multi-position actuator with respect to a second switch contact; and
processing the first and second ternary signals to determine the desired operating state, wherein a first operating state corresponds to a the first ternary signal having the high value and the second ternary signal having the low value, a second operating state corresponds to the first ternary signal having the low value and the second ternary signal having the high value, and a third operating state corresponds to the first and second ternary signals each having the intermediate state.

29. The method of claim 28 wherein the intermediate state corresponds to an open circuit.

30. The method of claim 28 wherein the third operating state corresponds to a default state.

31. The method of claim 28 wherein the controlled device is a cruise control.

32. The method of claim 30 wherein the first and second operating states correspond to Set/Coast and Resume/Accelerate signals, respectively.

33. The method of claim 28 wherein the controlled device is a power takeoff.

34. The method of claim 28 wherein the first and second operating states correspond to Set1 and Set2 states of the power takeoff, respectively.

35. The method of claim 28 wherein the first and second operating states correspond to Economy and Performance states, respectively, and the third operating state corresponds to a normal operating state.

36. The method of claim 28 wherein the first and second operating states correspond to Tap Up and Tap Down states, respectively.

37. An apparatus for determining a desired operating state of a controlled device from a position of a multi-position actuator, the apparatus comprising:
means for receiving electrical signals configured to receive first and second ternary signals each having a low value, an intermediate value or a high value indicative of the position of the multi-position actuator with respect to first and second switch contacts, respectively; and
means for processing the first and second ternary signals to determine the desired operating state, wherein a first operating state corresponds to a the first ternary signal having the high value and the second ternary signal having the low value, a second operating state corresponds to the first ternary signal having the low value and the second ternary signal having the high value, and a third operating state corresponds to the first and second ternary signals each having the intermediate state.
